(19) United States
(12) Patent Application Publication
(10) Pub. No.: US 2022/0021067 A1
(43) Pub. Date: Jan. 20, 2022

(54) BATTERY MODULE, BATTERY PACK AND VEHICLE

(71) Applicant: CONTEMPORARY AMPEREX TECHNOLOGY CO., LIMITED, Ningde City (CN)

(72) Inventors: Xiaoshan DAI, Ningde City (CN); Shoujiang XU, Ningde City (CN)

(73) Assignee: CONTEMPORARY AMPEREX TECHNOLOGY CO., LIMITED, Ningde City (CN)

(21) Appl. No.: 17/488,504

(22) Filed: Sep. 29, 2021

Related U.S. Application Data
(63) Continuation of application No. PCT/CN2020/104675, filed on Jul. 25, 2020.

(30) Foreign Application Priority Data
Sep. 20, 2019 (CN) 201921576330.X

(51) Int. Cl. H01M 50/291; H01M 50/209; H01M 50/293; H01M 10/04

(52) U.S. Cl. CPC H01M 50/291; H01M 50/209; H01M 50/242; H01M 10/0431; H01M 2220/20; H01M 50/293

(57) ABSTRACT

A battery module, a battery pack and a vehicle are provided. The battery module includes a battery and a buffer element. The buffer element is arranged between two adjacent batteries and has a main body portion, a first limiting portion and a second limiting portion. The main body portion is provided with an opening, the first limiting portion and the second limiting portion are located at both ends of the main body portion in a first direction and are arranged at intervals from the opening. The battery faces the opening and abuts against the main body portion, and is located between the first limiting portion and the second limiting portion, thereby improving a grouping efficiency of the battery module.

### CROSS-REFERENCE TO RELATED APPLICATIONS

The present application is a continuation of International Application No. PCT/CN2020/104675, filed on Jul. 25, 2020, which claims priority to Chinese Patent Application CN201921576330.X, filed on Sep. 20, 2019. The disclosures of the aforementioned applications are hereby incorporated by reference in their entireties.

### TECHNICAL FIELD

The present application relates to the technical field of batteries, and in particular, relates to a battery module, a battery pack and a vehicle.

### BACKGROUND

A battery module usually includes a plurality of batteries grouped together. In a grouping technology, in order to alleviate an impact of an expansion force of a battery on a battery life, a buffer element is usually arranged between two adjacent batteries. However, the existing buffer element is usually a flatplate structure, thus it has the following problems in a grouping process: (1) a positioning installation with the corresponding battery cannot be implemented, resulting in a low grouping efficiency; (2) the buffer element is easy to install improperly (that is, there is a certain misalignment between the buffer element and the corresponding battery), which affects an absorption effect of the buffer element on the expansion force of the battery.

### SUMMARY

In view of problems in the background art, a purpose of the present application is to provide a battery module, a battery pack, and a vehicle to improve a grouping efficiency and an absorption effect of a buffer element on an expansion force of a battery, thereby increasing a service life of the battery module.

In order to implement the above purpose, the present application provides a battery module, which includes a plurality of batteries and a buffer element. The plurality of the batteries are arranged side by side along a second direction. The buffer element is arranged between two adjacent batteries and has a main body portion, a first limiting portion and a second limiting portion. The main body portion is provided with an opening penetratingly along the second direction, the first limiting portion and the second limiting portion are located at both ends of the main body portion in a first direction and are arranged at intervals from the opening, and the first limiting portion and the second limiting portion are connected to the main body portion and protrude from the main body portion in the second direction. A battery faces the opening in the second direction and abuts against the main body portion and is located between the first limiting portion and the second limiting portion in the first direction.

In one embodiment according to the present application, the first limiting portion spans the entire main body portion in a third direction.

In one embodiment according to the present application, the second limiting portion spans the entire main body portion in the third direction.

In one embodiment according to the present application, the first limiting portion and the second limiting portion are arranged to be diametrically opposite to each other or arranged in a misalignment manner in the third direction.

In one embodiment according to the present application, the buffer element further has a third limiting portion, the third limiting portion is connected to the main body portion and protrudes from the main body portion in the second direction, and the third limiting portion supports the corresponding battery in the third direction.

In one embodiment according to the present application, the third limiting portion spans the entire main body portion in the first direction and is connected to the first limiting portion and the second limiting portion.

Or in another embodiment according to the present application, the third limiting portion is formed at both ends of the main body portion in the first direction, and the first limiting portion and the second limiting portion are connected to a corresponding third limiting portion, respectively.

In one embodiment according to the present application, the battery module further includes an insulation element, and the insulation element is arranged on both sides of the plurality of the batteries in the first direction and is bonded to the plurality of the batteries; a size of the battery in the second direction is W, a size of the first limiting portion in the second direction is H, and H≤W/20.

In one embodiment according to the present application, the battery includes an electrode assembly and a housing accommodating the electrode assembly; the housing is formed with a first fillet, and a radius of the first fillet is R₁; and a size of the first limiting portion in the second direction is H, and R₁≤H.

In one embodiment according to the present application, a junction between the first limiting portion and the main body portion is formed with a second fillet, and a radius of the second fillet is R₂, and R₁≤R₂.

In one embodiment according to the present application, the battery includes the electrode assembly and the housing accommodating the electrode assembly. The electrode assembly has a body portion, a first corner portion and a second corner portion, the first corner portion and the second corner portion are located at both sides of the body portion in the first direction, and the first corner portion and the second corner portion are connected to the body portion and protrude from the body portion in the first direction; a distance between a junction of the first corner portion and the body portion and an outer side surface corresponding to the housing in the first direction is L₁, and a distance between a junction of the second corner portion and the body portion and the outer side surface corresponding to the housing in the first direction is L₂. The main body portion of the buffer element has an inner peripheral surface enclosing the opening, and the inner peripheral surface includes a first surface and a second surface, and the first surface and the second surface are arranged oppositely in the first direction. The first surface is close to the first limiting portion and a distance between the first surface and the first limiting portion in the first direction is W₁, the second surface is close to the second limiting portion and a distance between the second surface and the second limiting portion in the first direction is W₂, and W₁≤L₁, W₂≤L₂.

In one embodiment according to the present application, a distance between the body portion and a lower surface of the housing in the third direction is L₃, and a distance between the body portion and an upper surface of the housing in the third direction is L₄. The inner peripheral surface further includes a third surface and a fourth surface, and the third surface and the fourth surface are arranged oppositely in the third direction. The third surface is close to the third limiting portion and a distance between the third surface and the third limiting portion in the third direction is W₃, a distance between the fourth surface and an upper surface of the main body portion in the third direction is W₄, and W₃≤L₃, W₄≤L₄.

In one embodiment according to the present application, the electrode assembly is a rolled electrode assembly.

In one embodiment according to the present application, the buffer element is made of a hard material.

In one embodiment according to the present application, a surface of each battery facing the opening is provided with a bonding adhesive, and the bonding adhesive is located at an inner side of the main body portion and is arranged close to the main body portion.

In another aspect, the present application further provides a battery pack, which includes the above battery module.

In addition, the present application further provides a vehicle, which includes the above battery pack configured to supply electric energy to the vehicle.

The technical solution of the present application has the following beneficial effects:

In a grouping process of the battery module, the main body portion of the buffer element, the first limiting portion and the second limiting portion together limit an installation position of the battery, thereby improving a grouping efficiency of the battery module. And during use of the battery module, the opening of the buffer element faces the battery in the second direction, so that the opening may absorb expansion and deformation generated by the battery in time, and based on an arrangement of the first limiting portion and the second limiting portion, the battery may not be misaligned relative to the buffer element in the first direction, which improves an absorption effect of the buffer element on the expansion and deformation of the battery, thereby increasing a service life of the battery module.

### BRIEF DESCRIPTION OF DRAWINGS

FIG. 1 is an exploded view of a battery module of the present application.

FIG. 2 is an assembly diagram of FIG. 1.

FIG. 3 is a sectional view before a buffer element and a corresponding battery are assembled in FIG. 1.

FIG. 4 is a modified example of a buffer element in 3.

FIG. 5 is a schematic diagram of an internal structure of a battery in a battery module.

FIG. 6 is a perspective view of a buffer element in FIG. 1.

FIG. 7 is a front view of FIG. 6.

FIG. 8 is a schematic diagram of a positional relationship between a buffer element and a bonding adhesive on a surface of a battery.

FIG. 9 is a modified example of FIG. 6.

FIG. 10 is another modified example of FIG. 6.

FIG. 11 is yet another modified example of FIG. 6.

FIG. 12 is an exploded view of a battery.

FIG. 13 is a schematic diagram of an outline of an electrode assembly in FIG. 12.

Reference signs are explained as follows:
battery

11 electrode assembly

111 body portion

112 first corner portion

113 second corner portion

11a first electrode sheet

11b second electrode sheet

11c isolation film

12 housing

13 top cover assembly

13a top cover plate

13b electrode terminal

2 buffer element

21 main body portion

21A first surface

21B second surface

21C third surface

21D fourth surface

22 first limiting portion

23 second limiting portion

24 third limiting portion

3 insulation element

4 upper cover plate

5 end plate

T bonding adhesive

S opening

X first direction

Y second direction Z third direction

### DESCRIPTION OF EMBODIMENTS

To make the objectives, technical solutions, and advantages of the present application clearer and more comprehensible, the present application will be further described below in detail with reference to the accompanying drawings and embodiments. It should be understood that the specific embodiments described herein are merely used to explain the present application, but are not intended to limit the present application.

In the description of the present application, unless otherwise specified and limited explicitly, the terms “first”, “second” and “third” are merely intended for a purpose of description, and may not be understood as an indication or implication of relative importance. The term “a plurality of” refers to more than two (including two). Unless otherwise specified or illustrated, the term “connection” should be understood broadly, for example, the “connection” may either be a fixed connection, or a detachable connection, or an integrated connection, or an electrical connection, or a signal connection; and the “connection” may either be a direct connection, or an indirect connection through an intermediary. Those of ordinary skill in the art may appreciate the specific meanings of the foregoing terms in the present application according to specific conditions.

In the description of the specification, it should be understood that the terms representing directions such as “up” and “down” described in the embodiments of the present application are described from the angles shown in the accompanying drawings, and should not be understood as limitation on the embodiments of the present application. The present application will be further described below in detail through the specific embodiments with reference to the accompanying drawings.

A vehicle of the present application includes a vehicle body, a battery pack and a power source. Both the battery pack and the power source are installed on the vehicle body, and the battery pack is electrically connected to the power source to supply electricity to the power source. Where the vehicle may be a new energy automobile. In one implementation manner, the new energy automobile may be a pure electric automobile, a hybrid automobile or an extended-range automobile. In one embodiment, the battery pack may be horizontally arranged at a bottom of the vehicle body.

The battery pack includes a box body and a battery module. The number of a battery module 1 may be one or more, and each battery module 1 may be fixed to the box body by a corresponding fastener (such as a bolt), or each battery module 1 may be fixed to the box body by a bonding method.

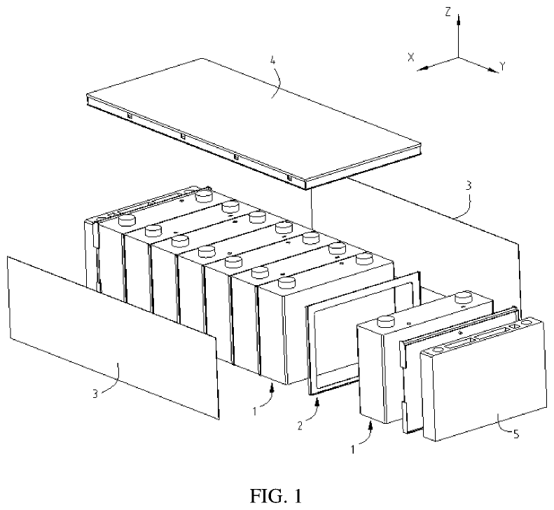

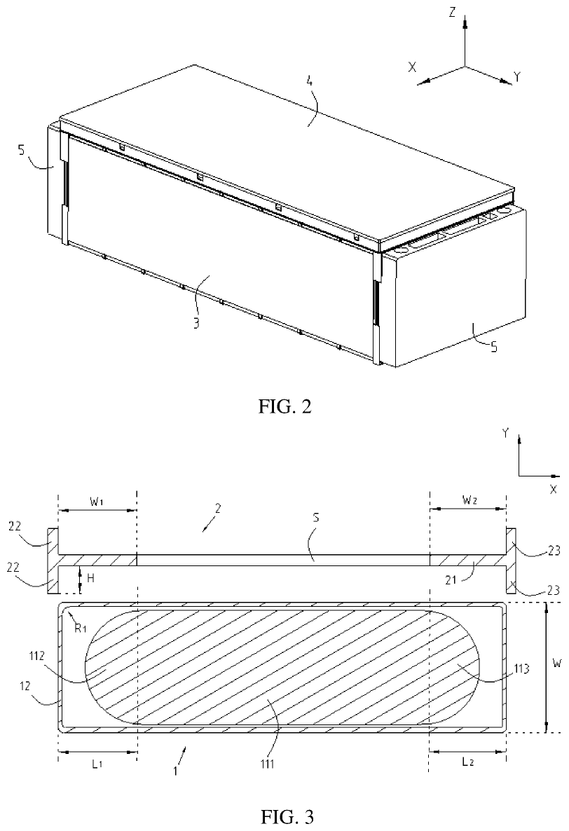

Referring to FIG. 1 and FIG. 2, the battery module may include a plurality of batteries 1, a buffer element 2, an insulation element 3, an upper cover plate 4 and an end plate 5.

The plurality of batteries 1 are arranged side by side along a second direction Y, and each battery 1 includes an electrode assembly 11, a housing 12, a top cover assembly 13 and an electrolyte accommodated in the housing 12.

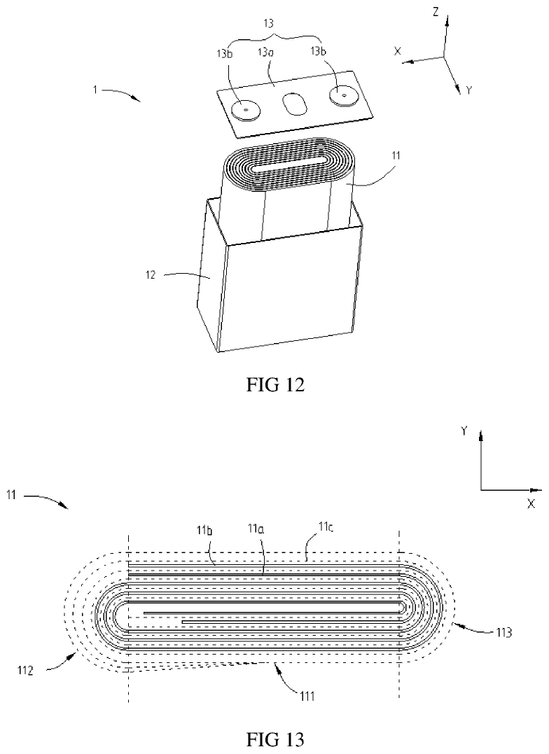

The electrode assembly 11 is accommodated in the housing 12, and for a composition structure of the electrode assembly 11, the electrode assembly 11 may include a first electrode sheet 11a, a second electrode sheet 12b, and an isolation film 11c arranged between the first electrode sheet 11a and the second electrode sheet 11b. In one embodiment, referring to FIG. 12 and FIG. 13, the electrode assembly 11 may be a rolled electrode assembly. In one implementation manner, the first electrode sheet 11a, the second electrode sheet 11b and the isolation film 11c are all in banded structures, the first electrode sheet 11a, the second electrode sheet 1 lb and the isolation film 11c are stacked in sequence and are rolled more than two turns to form the electrode assembly 11, and the electrode assembly 11 is in a flat shape. When producing the electrode assembly 11, the electrode assembly 11 may be firstly rolled into a hollow cylindrical structure, and then flattened into a flat shape after being rolled.

For different parts of the electrode assembly 11 in a first direction X, referring to FIG. 3 and FIG. 13, the electrode assembly 11 may have a body portion 111, a first corner portion 112 and a second corner portion 113, the body portion 111 extends along the first direction X, the first corner portion 112 and the second corner portion 113 are located at both sides of the body portion 111 in the first direction X, and the first corner portion 112 and the second corner portion 113 are connected to the body portion 111 and protrude from the body portion 111 in the first direction X, where an outer surface of the first corner portion 112 and an outer surface of the second corner portion 113 are formed in an arc shape.

The housing 12 can be made of metal materials or composite materials. For example, in one embodiment, the whole housing 12 is made of metal materials such aluminum, aluminum alloy or nickel-plated steel. Or in another embodiment, the housing 12 may also include a base and an insulation layer. The base is made of metal materials such aluminum, aluminum alloy or nickel-plated steel, and the insulation layer may be arranged on an outer surface of the base by coating, bonding or the like.

In this case, the metal base may ensure strength of the housing 12, and the insulation layer may improve an insulation property of the housing 12.

Referring to FIG. 12, the housing 12 may have a hexahedral shape or another shape. The housing 12 has an opening, and the electrode assembly 11 may be disposed in the housing 12 through the opening.

Referring to FIG. 12, the top cover assembly 13 may include a top cover plate 13a and electrode terminals 13b, and the electrode terminals 13b are arranged on the top cover plate 13a. The top cover plate 13a may be made of metal materials such as aluminum or aluminum alloy, and a size of the top cover plate 13a is adapted to a size of the opening of the housing 12. The top cover plate 13a may be connected to the housing 12 by welding and cover the opening of the housing 12, thereby sealing the electrode assembly 11 and the electrolyte in the housing 12.

The electrode terminals 13b may be fixed to the top cover plate 13a by welding, riveting or the like. There are two electrode terminals 13b, and they are electrically connected to the first electrode sheet 11a and the second electrode sheet 11b, respectively.

Referring to FIG. 1, the buffer element 2 is arranged between two adjacent batteries 1. In one implementation manner, the buffer element 2 may be made of hard materials (such as PC, PP and the like). At this time, the buffer element 2 is incompressible, so that an assembly preload and a reserved expansion gap between each two adjacent batteries 1 may be ensured to be consistent, thereby improving a reliability of a module structure during a long-term use.

Referring to FIGS. 3 to 11, the buffer element 2 may have a main body portion 21, a first limiting portion 22 and a second limiting portion 23. According to actual situations, the buffer element 2 may also have a third limiting portion 24.

The main body portion 21 of the buffer element 2 is provided with an opening S penetratingly along the second direction Y to form a loop structure. The first limiting portion 22 and the second limiting portion 23 are located at both ends of the main body portion 21 in the first direction X and are arranged at intervals from the opening S (that is, a distance between the first limiting portion 22 and the second limiting 23 in the first direction X is greater than a size of the opening S in the first direction), and the first limiting portion 22 and the second limiting portion 23 are connected to the main body portion 21 and protrude from the main body portion 21 in the second direction Y. When the battery module is grouped, the housing 12 of a battery 1 faces the opening S in the second direction Y and abuts against the main body portion 21 of the buffer element 2, and is located between the first limiting portion 22 and the second limiting portion 23 in the first direction X.

In a grouping process of the battery module, the main body portion 21 of the buffer element 2, the first limiting portion 22 and the second limiting portion 23 together limit an installation position of the battery 1, thereby improving a grouping efficiency of the battery module. And during use of the battery module, the opening S of the buffer element 2 faces the battery 1 in the second direction Y, so that the opening S may absorb expansion and deformation generated by the battery 1 in time, and based on an arrangement of the first limiting portion 22 and the second limiting portion 23, the battery 1 may not be misaligned relative to the buffer element 2 in the first direction X, which improves an absorption effect of the buffer element 2 on the expansion and deformation of the battery 1, thereby increasing a service life of the battery module.

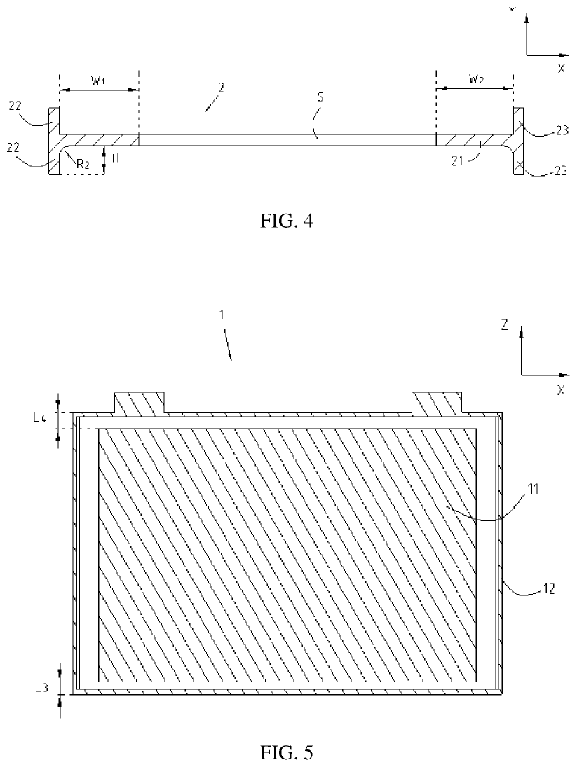

The first limiting portion 22 may be formed at one side or both sides of the main body portion 21 in the second direction Y (as shown in FIG. 3 and FIG. 4). Accordingly, the second limiting portion 23 may be formed at one side or both sides of the main body portion 21 in the second direction Y (as shown in FIG. 3 and FIG. 4).

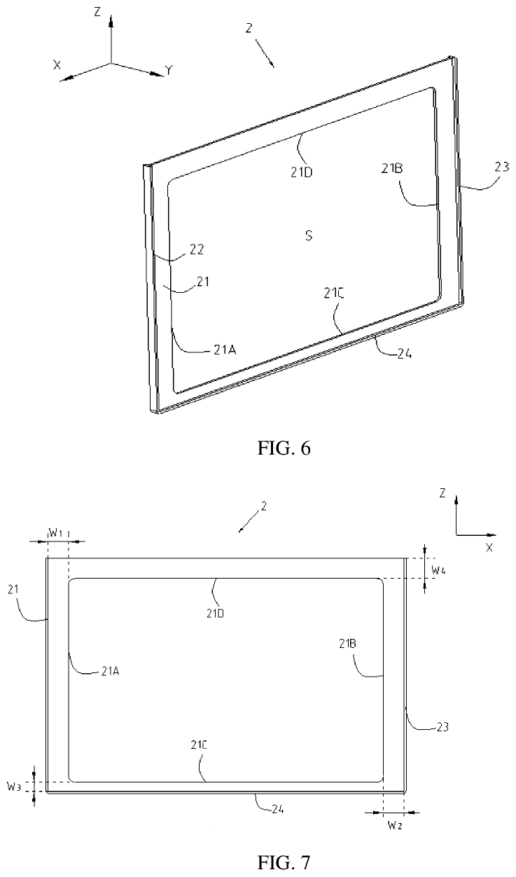

In order to ensure strength of the first limiting portion 22, referring to FIG. 6 and FIG. 7, the first limiting portion 22 may span the entire main body portion 21 in a third direction Z, that is, the first limiting portion 22 extends from one end of the main body portion 21 to the other end in the third direction Z. Of course, the first limiting portion 22 may also span a part of the main body portion 21 in the third direction Z, which helps to save materials of the buffer element 2 at this time, thereby reducing costs. In one implementation manner, the first limiting portion 22 is arranged in the middle of the main body portion 21 in the third direction Z (as shown in FIG. 9).

Accordingly, referring to FIG. 6 and FIG. 7, the second limiting portion 23 spans the entire main body portion 21 in the third direction Z, that is, the second limiting portion 23 extends from one end of the main body portion 21 to the other end in the third direction Z. Of course, the second limiting portion 23 may also span the part of the main body portion 21 in the third direction Z. At this time, in one implementation manner, the second limiting portion 23 is arranged in the middle of the main body portion 21 in the third direction Z (as shown in FIG. 9).

When the first limiting portion 22 spans the part of the main body portion 21 in the third direction Z and the second limiting portion 23 also spans the part of the main body portion 21 in the third direction Z, the first limiting portion 22 and the second limiting portion 23 may be arranged to be diametrically opposite to each other (as shown in FIG. 9) or arranged in a misalignment manner in the third direction Z. It should be noted that the “diametrically opposite arrangement” means that a projection of the first limiting portion 22 in the first direction X and a projection of the second limiting portion 23 in the first direction X overlap, and the “misaligning arrangement” means that the projection of the first limiting portion 22 in the first direction X and the projection of the second limiting portion 23 in the first direction X partially overlap or do not overlap.

Referring to FIGS. 6 to 11, the third limiting portion 24 is connected to the main body portion 21 and protrudes from the main body portion 21 in the second direction Y, and the third limiting portion 24 supports the corresponding battery 1 in the third direction Z. Since the first limiting portion 22 and the second limiting portion 23 of the buffer element 2 together limit a position of the battery 1 in the first direction X, and the third limiting portion 24 limits a position of the battery 1 in the third direction Z, when the battery module is grouped, it is only necessary to dispose the battery 1 in an area formed by the third limiting portion 24, the first limiting portion 22 and the second limiting portion 23, thereby improving the grouping efficiency of the battery module.

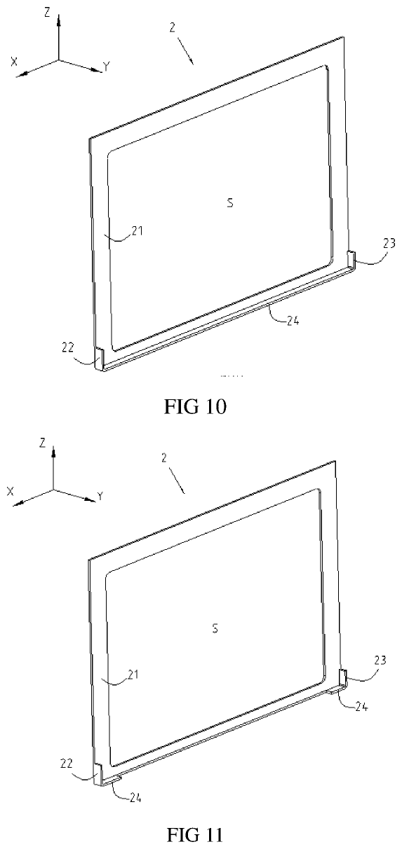

In order to ensure strength of the third limiting portion 24, the third limiting portion 24 may span (that is, the third limiting portion 24 extends from one end of the main body portion 21 to the other end in the first direction X, as shown in FIG. 10) the entire main body portion 21 in the first direction X and is connected to the first limiting portion 22 and the second limiting portion 23. Of course, in order to save the materials of the buffer element 2 to reduce the costs, the third limiting portion 24 may also span the part of the main body portion 21 in the first direction X. In one implementation manner, the third limiting portion 24 is arranged in the middle of the main body portion 21 in the first direction X. Referring to FIG. 11, the third limiting portion 24 may also be formed at both ends of the main body portion 21 in the first direction X, and the first limiting portion 22 and the second limiting portion 23 are connected to a corresponding third limiting portion 24, respectively.

Referring to FIG. 1 and FIG. 2, the insulation element 3 extends along the second direction Y and is arranged at both sides of the plurality of the batteries 1 in the first direction X, and the insulation element 3 is bonded to the plurality of the batteries 1 to insulate the plurality of the batteries 1. In one implementation manner, a surface of the battery 1 is further provided with a protective film, and the insulation element 3 is bonded to the protective film of surfaces of the plurality of the batteries 1.

Referring to FIG. 3, a size of the battery 1 in the second direction Y is W, a size of the first limiting portion 22 in the second direction Y is H, and H≤W/20.This is because when H>W/20, the size H of the first limiting portion 22 in the second direction Y is too large, then a part of a side of the battery 1 corresponding to the first limiting portion 22 is too large, and a part of the side of the battery 1 that may be bonded to the insulation element 3 is shorter, thereby resulting in that a bonding effect between the insulation element 3 and the battery 1 is poor and even the insulation element 3 may not be bonded to the battery 1, further resulting in that the protective film of the surface of the battery 1 is worn, and resulting in an insulation failure of the battery 1 accordingly.

Referring to FIG. 3, the housing 12 of the battery 1 is formed with a first fillet, and a radius of the first fillet is R₁, a size of the first limiting portion 22 in the second direction Y is H, and H≥R₁. This is because when H<R₁, a size H of the first limiting portion 22 in the second direction Y is too small, so that when the battery module is subjected to external shock and vibration, the battery 1 is likely to fall out between the first limiting portion 22 and the second limiting portion 23, which may not guarantee an limiting effect of the battery module on the battery 1 during the long-term use.

Referring to FIG. 4, a junction between the first limiting portion 22 and the main body portion 21 is formed with a second fillet, and a radius of the second fillet is R₂, R₁≤R₂, and at this time, assembly between the battery 1 and the buffer element 2 is facilitated. Of course, a junction between the first limiting portion 22 and the main body portion 21 may also be formed into a right angle.

Inside the housing 12 of the battery 1, in order to alleviate expansion and deformation generated by the electrode assembly 11, a certain expansion space is reserved between the electrode assembly 11 and the corresponding housing 12, that is, a distance between a junction of the first corner portion 112 and the body portion 111 of the electrode assembly 11 and an outer side surface corresponding to the housing 12 in the first direction X is L₁, a distance between a junction of the second corner portion 113 and the body portion 111 and the outer side surface corresponding to the housing 12 in the first direction X is L₂, a distance between the body portion 111 and a lower surface of the housing 12 in the third direction Z is L₃, and a distance between the body portion 111 and an upper surface of the housing 12 in the third direction Z is L₄, as shown in FIG. 3 and FIG. 5.

Referring to FIG. 6 and FIG. 7, the main body portion 21 of the buffer element 2 has an inner peripheral surface enclosing the opening S, and the inner peripheral surface includes a first surface 21A, a second surface 21B, a third surface 21C and a fourth surface 21D, and the first surface 21A and the second surface 21B are arranged oppositely in the first direction X, and the third surface 21C and the fourth surface 21D are arranged oppositely in the third direction Z.

The first surface 21A is arranged close to the first limiting portion 22 and a distance between the first surface 21A and the first limiting portion 22 in the first direction X is W₁, the second surface 21B is arranged close to the second limiting portion 23 and a distance between the second surface 21B and the second limiting portion 23 in the first direction X is W₂, as shown in FIG. 3 and FIG. 7. During an expansion and deformation process of the electrode assembly 11, in order to prevent an expansion force generated by the electrode assembly 11 and the main body portion 21 of the buffer element 2 from being pressed against each other, W₁≤L₁, W₂≤L₂ (that is, the whole electrode assembly 11 is located inside the opening S in the first direction X), thereby avoiding a damage to the electrode assembly 11 due to stress concentration.

The third surface 21C is arranged close to the third limiting portion 24 and a distance between the third surface 21C and the third limiting portion 24 in the third direction Z is W₃, a distance between the fourth surface 21D and an upper surface of the main body portion 21 in the third direction Z is W₄, as shown in FIG. 7. During the expansion and deformation process of the electrode assembly 11, in order to prevent the expansion force generated by the electrode assembly 11 and the main body portion 21 of the buffer element 2 from being pressed against each other, W₃≤L₃, W₄≤L₄ (that is, the whole electrode assembly 11 is located inside the opening S in the third direction Z), thereby avoiding the damage to the electrode assembly 11 due to the stress concentration.

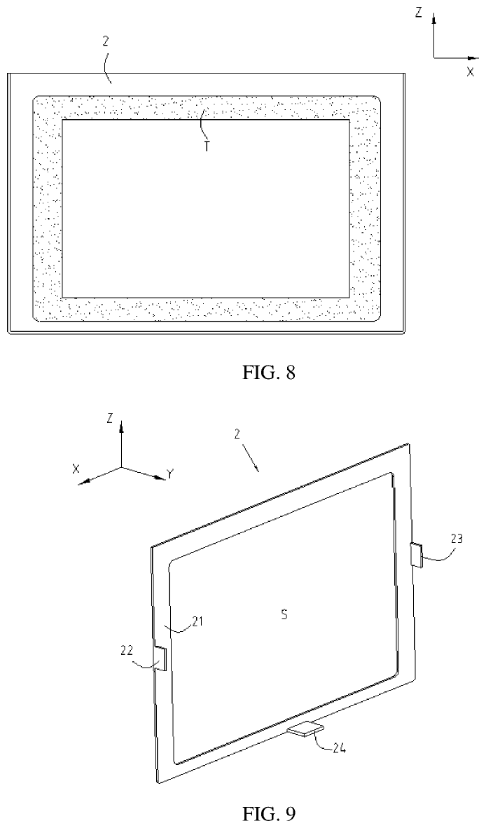

A surface of each battery 1 facing the opening S is also provided with a bonding adhesive T, and two adjacent batteries 1 are connected together through the corresponding bonding adhesive T. In order to prevent the battery 1 from causing a bonding failure under an action of an expansion force, the bonding adhesive T of the surface of the battery 1 is located inside the main body portion 21 and is arranged close to the main body portion 21. At this time, the bonding adhesive T is formed into the loop structure, as shown in FIG. 8. In addition, according to requirements of the battery module for a bonding strength between the two adjacent batteries 1, a width of the bonding adhesive T in a circumferential direction may be selected between 5 millimeters (mm) and 15 millimeters (mm).

What is claimed is:

1. A battery module, comprising a plurality of batteries and a buffer element;
the plurality of batteries are arranged side by side along a second direction;
the buffer element is arranged between two adjacent batteries and has a main body portion, a first limiting portion and a second limiting portion;
the main body portion is provided with an opening penetratingly along the second direction, the first limiting portion and the second limiting portion are located at both ends of the main body portion in a first direction, respectively, and are arranged at intervals from the opening, and the first limiting portion and the second limiting portion are connected to the main body portion and protrude from the main body portion in the second direction; and
a battery faces the opening in the second direction and abuts against the main body portion, and the battery is located between the first limiting portion and the second limiting portion in the first direction.

2. The battery module according to claim 1, wherein
the first limiting portion spans the entire main body portion in a third direction; and/or
the second limiting portion spans the entire main body portion in the third direction.

3. The battery module according to claim 1, wherein the first limiting portion and the second limiting portion are arranged to be diametrically opposite to each other or arranged in a misalignment manner in the third direction.

4. The battery module according to claim 1, wherein the buffer element further has a third limiting portion, the third limiting portion is connected to the main body portion and protrudes from the main body portion in the second direction, and the third limiting portion supports the corresponding battery in the third direction.

5. The battery module according to claim 4, wherein
the third limiting portion spans the entire main body portion in the first direction and is connected to the first limiting portion and the second limiting portion; or
the third limiting portion is formed at both ends of the main body portion in the first direction, and the first limiting portion and the second limiting portion are connected to a corresponding third limiting portion, respectively.

6. The battery module according to claim 1, wherein
the battery module further comprises an insulation element, and the insulation element is arranged at both sides of the plurality of the batteries in the first direction and is bonded to the plurality of the batteries; and
a size of the battery in the second direction is W, a size of the first limiting portion in the second direction is H, and H≤W/20 .

7. The battery module according to claim 1, wherein
the battery comprises an electrode assembly and a housing accommodating the electrode assembly;
the housing is formed with a first fillet, and a radius of the first fillet is R₁; and
a size of the first limiting portion in the second direction is H, and R₁≤H.

8. The battery module according to claim 7, wherein a junction between the first limiting portion and the main body portion is formed with a second fillet, and a radius of the second fillet is R₂, and R₁≤R₂.

9. The battery module according to claim 4, wherein
the battery comprises the electrode assembly and the housing accommodating the electrode assembly;
the electrode assembly has a body portion, a first corner portion and a second corner portion, the first corner portion and the second corner portion are located at both sides of the body portion in the first direction, respectively, and the first corner portion and the second corner portion are connected to the body portion and protrude from the body portion in the first direction;
a distance between a junction of the first corner portion and the body portion and an outer side surface corresponding to the housing in the first direction is L₁, and a distance between a junction of the second corner portion and the body portion and the outer side surface corresponding to the housing in the first direction is L₂;
the main body portion of the buffer element has an inner peripheral surface enclosing the opening, and the inner peripheral surface comprises a first surface and a second surface, and the first surface and the second surface are arranged oppositely in the first direction; and
the first surface is close to the first limiting portion and a distance between the first surface and the first limiting portion in the first direction is W₁, the second surface is close to the second limiting portion and a distance between the second surface and the second limiting portion in the first direction is W₂, and W₁≤L₁, W₂≤L₂.

10. The battery module according to claim 9, wherein
a distance between the body portion and a lower surface of the housing in the third direction (Z) is L₃, and a distance between the body portion and an upper surface of the housing in the third direction (Z) is L₄;
the inner peripheral surface further comprises a third surface and a fourth surface, and the third surface and the fourth surface are arranged oppositely in the third direction; and
the third surface is close to the third limiting portion and a distance between the third surface and the third limiting portion in the third direction is W₃, a distance between the fourth surface and an upper surface of the main body portion in the third direction is W₄, and W₃≤L₃, W₄≤L₄.

11. The battery module according to claim 7, wherein the electrode assembly is a rolled electrode assembly.

12. The battery module according to claim 1, wherein the buffer element is made of a hard material.

13. The battery module according to claim 1, wherein a surface of each battery facing the opening is provided with a bonding adhesive, and the bonding adhesive is located at an inner side of the main body portion and is arranged close to the main body portion.

14. A battery pack comprising:
a box body;
a battery module comprising a plurality of batteries and a buffer element;
the plurality of batteries are arranged side by side along a second direction;
the buffer element is arranged between two adjacent batteries and has a main body portion, a first limiting portion and a second limiting portion;
the main body portion is provided with an opening penetratingly along the second direction, the first limiting portion and the second limiting portion are located at both ends of the main body portion in a first direction, respectively, and are arranged at intervals from the opening, and the first limiting portion and the second limiting portion are connected to the main body portion and protrude from the main body portion in the second direction; and
a battery faces the opening in the second direction and abuts against the main body portion, and the battery is located between the first limiting portion and the second limiting portion in the first direction.

15. The battery pack according to claim 14, wherein
the first limiting portion spans the entire main body portion in a third direction; and/or
the second limiting portion spans the entire main body portion in the third direction;
wherein the first limiting portion and the second limiting portion are arranged to be diametrically opposite to each other or arranged in a misalignment manner in the third direction.

16. The battery pack according to claim 14, wherein the buffer element further has a third limiting portion, the third limiting portion is connected to the main body portion and protrudes from the main body portion in the second direction, and the third limiting portion supports the corresponding battery in the third direction;
wherein the third limiting portion spans the entire main body portion in the first direction and is connected to the first limiting portion and the second limiting portion; or
the third limiting portion is formed at both ends of the main body portion in the first direction, and the first limiting portion and the second limiting portion are connected to a corresponding third limiting portion, respectively.

17. The battery pack according to claim 14, wherein
the battery module further comprises an insulation element, and the insulation element is arranged at both sides of the plurality of the batteries in the first direction and is bonded to the plurality of the batteries; and
a size of the battery in the second direction is W, a size of the first limiting portion in the second direction is H, and H≤W/20 .

18. The battery pack according to claim 14, wherein
the battery comprises an electrode assembly and a housing accommodating the electrode assembly;
the housing is formed with a first fillet, and a radius of the first fillet is R₁; and
a size of the first limiting portion in the second direction is H, and R₁≤H;
wherein a junction between the first limiting portion and the main body portion is formed with a second fillet, and a radius of the second fillet is R₂, and R₁≤R₂.

19. The battery pack according to claim 16, wherein
the battery comprises the electrode assembly and the housing accommodating the electrode assembly;
the electrode assembly has a body portion, a first corner portion and a second corner portion, the first corner portion and the second corner portion are located at both sides of the body portion in the first direction, respectively, and the first corner portion and the second corner portion are connected to the body portion and protrude from the body portion in the first direction;
a distance between a junction of the first corner portion and the body portion and an outer side surface corresponding to the housing in the first direction is L₁, and a distance between a junction of the second corner portion and the body portion and the outer side surface corresponding to the housing in the first direction is L₂;
the main body portion of the buffer element has an inner peripheral surface enclosing the opening, and the inner peripheral surface comprises a first surface and a second surface, and the first surface and the second surface are arranged oppositely in the first direction; and
the first surface is close to the first limiting portion and a distance between the first surface and the first limiting portion in the first direction is W₁, the second surface is close to the second limiting portion and a distance between the second surface and the second limiting portion in the first direction is W₂, and W₁≤L₁, W₂≤L₂;
wherein
a distance between the body portion and a lower surface of the housing in the third direction (Z) is L₃, and a distance between the body portion and an upper surface of the housing in the third direction (Z) is L₄;
the inner peripheral surface further comprises a third surface and a fourth surface, and the third surface and the fourth surface are arranged oppositely in the third direction; and
the third surface is close to the third limiting portion and a distance between the third surface and the third limiting portion in the third direction is W₃, a distance between the fourth surface and an upper surface of the main body portion in the third direction is W₄, and W₃≤l₃, W₄≤L₄.

20. A vehicle comprising the battery module according to claim 1, and the battery module is configured to supply electric energy to the vehicle.
